(19) United States
(12) Patent Application Publication
(10) Pub. No.: US 2026/0233589 A1
(43) Pub. Date: Aug. 13, 2026

(54) THERMOPLASTIC TAILGATE PANEL REINFORCING FLANGE DESIGN FOR AUTOMATED BONDING PROCESS

(71) Applicant: Magna Exteriors Inc., Aurora (CA)

(72) Inventor: JIri DUBSKY

(73) Assignee: Magna Exteriors Inc., Aurora, ON (CA)

(21) Appl. No.: 19/470,644

(22) PCT Filed: May 2, 2024
(86) PCT No.: PCT/CA2024/050590

§ 371 Date: Sep. 29, 2025

Related U.S. Application Data
(60) Provisional application No. 63/499,609, filed on May 2, 2023.

(51) Int. Cl. B60J 5/10; B60Q 1/30; F21S 43/50

(52) U.S. Cl. CPC B60J 5/107; B60Q 1/30; F21S 43/50

(57) ABSTRACT

A tailgate for a vehicle formed of several composite pieces connected together, including an inner panel and an outer panel having a exterior surface and an inner surface. The exterior surface of the outer panel includes a light cavity with an aperture. The light cavity includes a plurality of side walls extending between a perimeter edge of the aperture and a back wall. The outer panel also includes a non-visual surface region having an inside surface and an bonding surface. The tailgate further includes at least one non-visual reinforcement flange connected at one end to the inside surface of the non-visual surface region of the inner panel and at a second end to one of the plurality of side walls of the light cavity. The non-visual reinforcement flange provides a connection between the at least one non-visual reinforcement flange and the bonding surface of the inner panel.

### FIELD OF THE INVENTION

The present invention relates to polymer tailgate or tailgates for vehicles and methods of assembly.

### BACKGROUND OF THE INVENTION

A current trend in the automobile industry is to lower vehicle weight to help achieve better fuel economy, to help meet fuel economy standards and offset the higher fuel prices. Another trend is to provide a broader range of vehicle models, which in turn reduces the volume of vehicles produced on a per model basis. Sport utility and crossover vehicles remain popular and typically include fairly heavy rear tailgates, making this part of the vehicle a target area for weight reduction. Tailgates, which are sometimes also referred to as liftgate, are traditionally made from stamped steel panels that are heavy and have a high tooling cost. Traditional steel tailgates are expensive investments that consume a lot of assembly floor space because of stamping, body shop, paint shop, and trim lines. Further, steel tailgates have limited styling flexibility, take a lot of time to tool, and have corrosion concerns.

Thermoplastics are an alternative to steel for the inner and outer panels of the tailgate. One challenge of forming thermoplastic tailgates is that typical tailgates are manufactured as a relatively flat or smoothly contoured panel, but thermoplastics panels also require structural reinforcements such as ribs added onto the panel in order to provide surfaces for bonding different components of the panel together. This increases manufacturing complexity because there are read through areas where the ribs are placed. For example, U.S. Pat. No. 10,723,208B2 entitled “TAILGATE FOR VEHICLE” describes a thermoplastic composite tailgate system with an outer panel having an optical housing where a bridge wall is located on an inside face of the outer panel and forms a bridge between the edge wall of the optical housing and the appearance wall and serves as part of a bonding interface between the outer panel and inner panel. However, the location of the bridge is problematic because it extends from an appearance wall, which causes sink marks or blemishes to be visible on the appearance surface of the outside panel. Therefore, there is a need to provide bridges between the attachment surface of the outside panel and the inner panel that will not have the unwanted blemishes and better visual appearance on the class A exterior surface 20. It is further an aspect of the present invention to increase outer panel stiffness and reduce deformations. Lastly it is an object of the present invention to provide better production tolerances between the inner and outer panel.

### SUMMARY OF THE INVENTION

A tailgate for a vehicle formed of several composite pieces connected together, including an inner panel having a bonding surface that is at least partially covered by an outer panel having an exterior surface and an inner surface. The exterior surface of the outer panel is the show surface, sometimes referred to as a class A finish surface of the tailgate and further includes a light cavity with an aperture in the exterior surface. The light cavity further includes a plurality of side walls extending between a perimeter edge of the aperture and back wall. The outer panel also includes a non-visual surface region having an inside surface and an exterior surface 20. The tailgate further includes at least one non-visual reinforcement flange connected at one end to the inside surface of the non-visual surface region of the inner panel and at a second end to one of the plurality of side walls of the at least one light cavity. The non-visual reinforcement flange provides a connection between the at least one non-visual reinforcement flange and the bonding surface of the inner panel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a finished side rear perspective view of a tailgate.

FIG. 2 is an exploded rear perspective view of the tailgate.

FIG. 3 is an exploded rear perspective view of the bonding surface of the inner panel and the inner surface of the outer panel.

FIG. 4 is a plan view of the inner surface of the outer panel.

FIG. 5 is a partial perspective view of a finished side of the outer panel.

FIG. 6 is a partial perspective view of an inner surface of the inner panel with the outer panel connected to the inner panel.

FIG. 7 is a partial perspective view of an inner surface of the outer panel.

FIG. 8 is a partial plan view of an inner surface of the outer panel.

FIG. 9 is a cross-sectional elevational view of the outer panel.

FIG. 10 is a partial plan view of the inner surface of the outer panel with a representation of the molding insert for forming the non-visual reinforcement flange and at least one styling line reinforcement flange.

FIG. 11 is a partial plan view of the inner surface of the outer panel with a representation of the continuous adhesive path for connecting the outer panel to the inner panel.

### DETAILED DESCRIPTION OF THE PREFERRED EMBODIMENTS

The following description of the preferred embodiment is merely exemplary in nature and is in no way intended to limit the invention, its application, or uses.

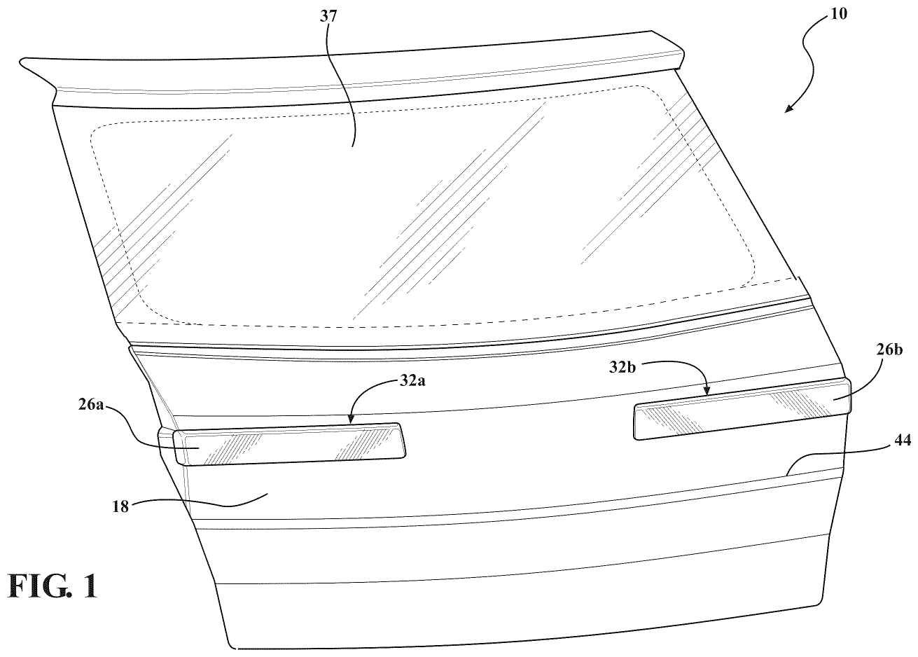

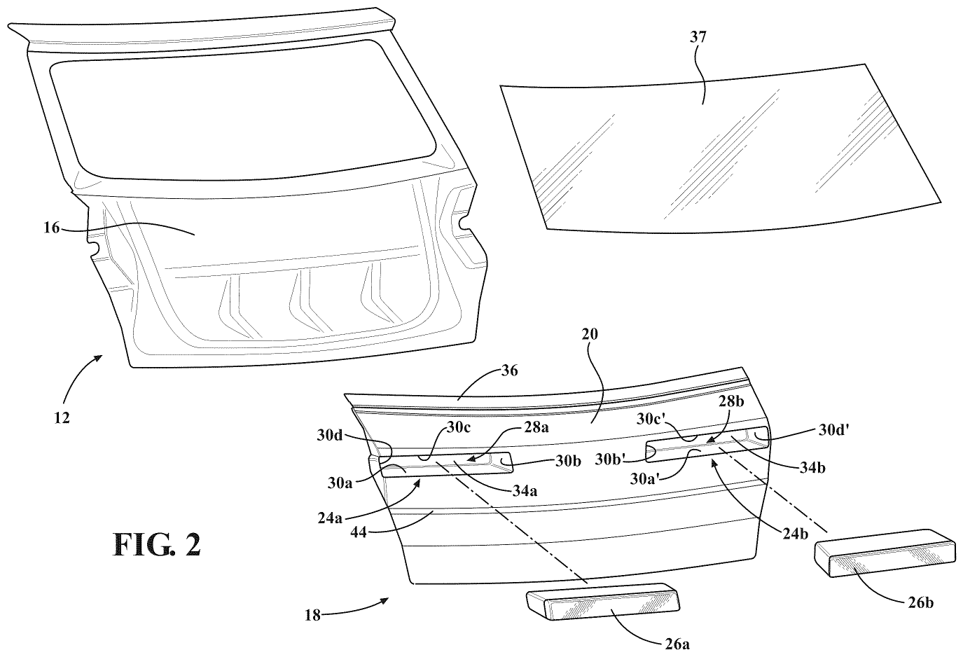

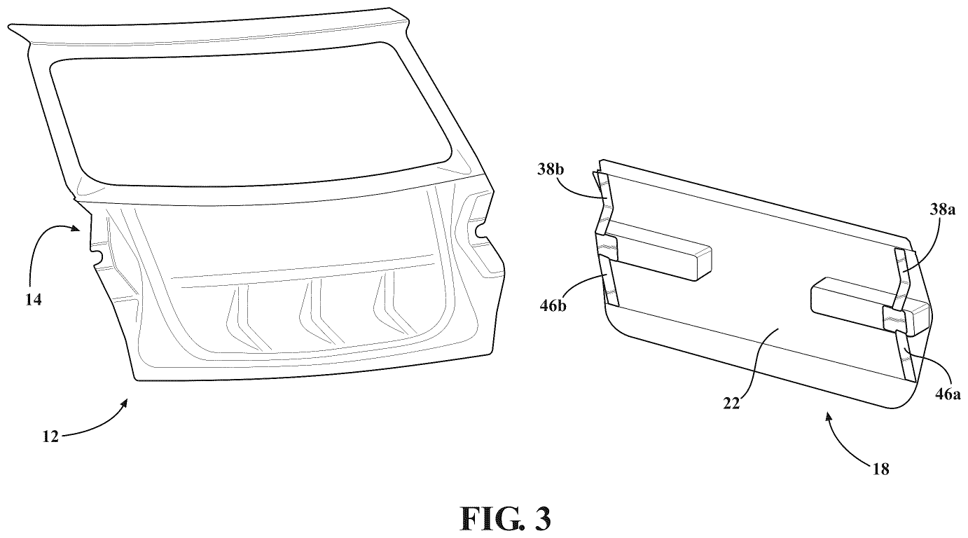

The term “tailgate” as used herein is to be considered to cover other similar terms, such as but not limited to a liftgate, door, trunk, frunk, split gate, pick-up truck tailgate, sliding door, hatch or any other composite automotive closure. Referring now to all of the figures generally, and FIGS. 1-3, a tailgate 10 for a vehicle formed of several composite pieces connected together, including an inner panel 12 having an inside surface 14 and a bonding surface 16 that is at least partially covered by an outer panel 18 having an exterior surface 20 and an inner surface 22. The exterior surface 20 of the outer panel 18 is a finished side, sometimes referred to as a class A finish surface of the tailgate 10. Referring now to all the drawings the exterior surface 20 of the outer panel 18 further includes two light cavities 24a, 24b that are also referred to herein in singular form as light cavity. The light cavities 24a, 24b each receive a respective tail lamp 26a, 26b . The tail lamp 26a, 26b is respectively positioned trough an aperture 28a, 28b of each light cavity 24a, 24b formed through the exterior surface 20 of the outer panel 18. The light cavity 24a, 24b each respectfully further include a plurality of side walls 30a, 30a′, 30b, 30b′, 30c, 30c′, 30d, 30d′ extending between a perimeter edge 32a, 32b of the aperture 28a, 28b and back wall 34a, 34b. The outer panel 18 also includes a non-visual surface region 36. The non-visual surface region 36 is a window flange that forms a portion of the exterior surface 20 of the portion of the outer panel 18, that is at least partially covered by a window 37.

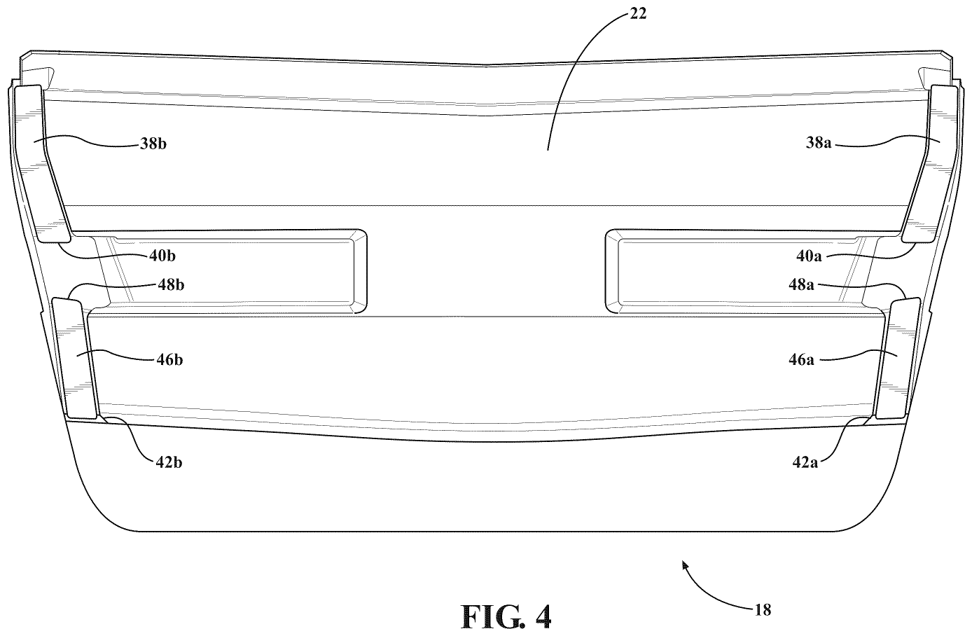

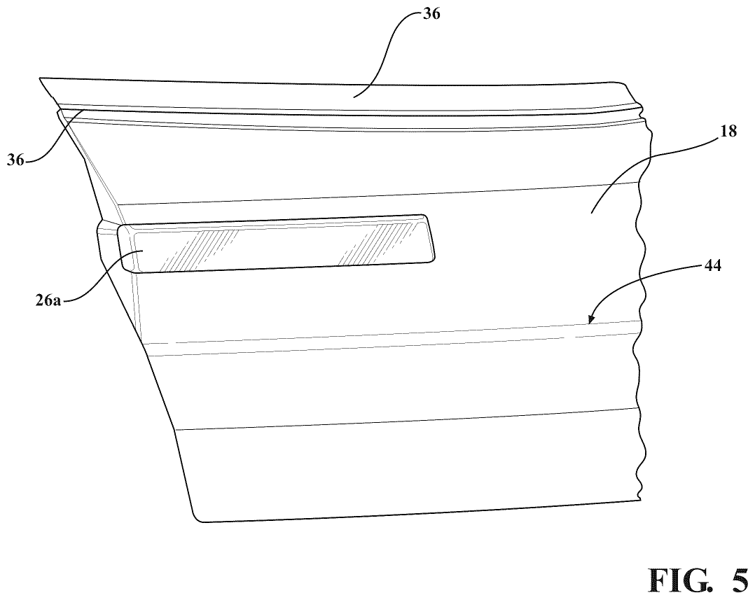

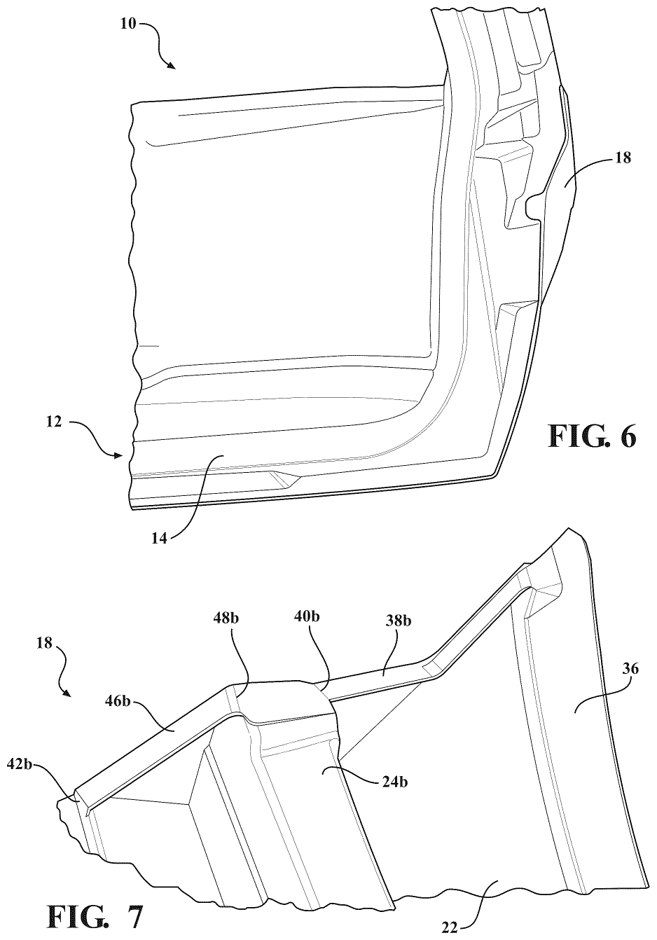

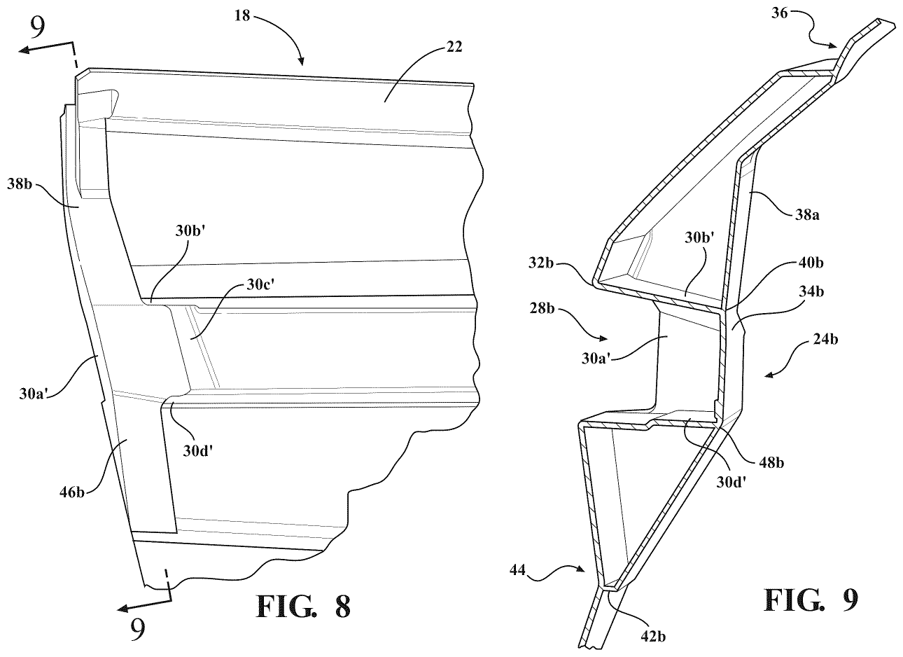

Referring now to FIGS. 4 and 7-9, on opposing sides of the inner surface 22 of the outer panel 18 of the tailgate 10 is a non-visual reinforcement flange 38a, 38b. Each non-visual reinforcement flange 38a, 38b is connected at one end to the inner surface 22 of the outer panel 18 at a location that is on a back side of the non-visual surface region 36. A second end of each non-visual flange 38a, 38b is connected to an intersect 40a, 40b of the side wall 30b, 30b′ and back wall 34a, 34b of a respective light cavity 24a, 24b. While the connection is shown at the intersect 40, it is within the scope of this invention for the connection between the second end of the non-visual flange 38a, 38b and the light cavity 24a, 24b to be at either the side wall 30b, 30b′ or the back wall 34a, 34b and not necessarily at the intersect 40a, 40b.

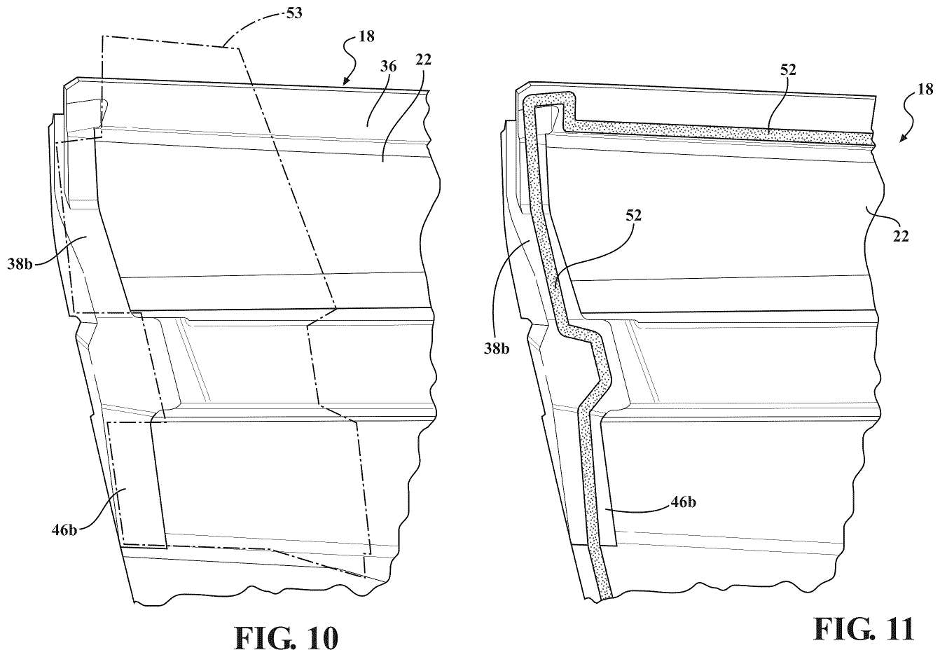

Each non-visual reinforcement flange 38a, 38b provide several advantages when forming the outer panel 18, and when connecting the outer panel 18 to the inner panel 12. The outer panel 18 is formed of composite material, which means it is formed within a molding tool. During formation there are sliders in the molding tool that help to release the formed outer panel after molding in the tool is complete. The non-visual reinforcement flange 38b provide a wide surface area (shown in FIG. 10) that allows for a slider 53 in the molding tool to push the outer panel 18 out of the tool upon completion of the forming of the outer panel 18. FIG. 10 shows a slider 53 on one side of the outer panel 18 in contact with the non-visual reinforcement flange 38b, however a separate slider (not shown) on the opposite side at the non-visual reinforcement flange 38a is also used. Additionally, each non-visual reinforcement flange 38a, 38b extends between the respective intersect 40a, 40b and the non-visual surface region 36 at a distance from the inner surface 22 of the outer panel 18. This prevents the sliders in the mold tool from directly contacting the inner surface 22 and exterior surface 20 of the outer panel 18, which helps to prevent any blemishes from being created on the exterior surface 20 or inner surface 22 that can be created during removal of the outer panel 18 from the mold tool.

Referring also to FIG. 11 one side of the outer panel shows that during assembly of the tailgate 10 the wide surface area on the non-visual reinforcement flange 38b is provided for the application of adhesives 52 or other bonding or connection devices to be applied so that there is good contact between the non-visual reinforcement flange 38b and the bonding surface 16 of the inner panel 12. While only one side of the inner surface 22 of the outer panel 18 is shown, the same adhesive path is applied on the opposing side at the non-visual reinforcement flange 38a.

On opposing sides of the inner surface 22 of the outer panel 18 of the tailgate 10 is a styling line reinforcement flange 46a, 46b. Each styling line reinforcement flange 46a, 46b is connected at one end to the inner surface 22 of the outer panel 18 at a location opposite a styling feature 44 located on the exterior surface 20 of the outer panel 18. Each styling line reinforcement flange 46a, 46b is connected at a second end to an intersect 48a, 48b of the side wall 30b, 30b′ and back wall 34a, 34b of a respective light cavity 24a, 24b. While the connection is shown at the intersect 48a, 48b, it is within the scope of this invention for the connection between the second end of the styling line reinforcement flange 46a, 46b and the light cavity 24a, 24b respectively, to be at either the side wall 30c, 30c′ or the back wall 34a, 34b and not necessarily at the intersect 48a, 48b.

The styling feature 44 is formed on the exterior surface 20 of the outer panel 18 and can take many forms. Generally, the styling feature 44 is an area on the exterior surface 20 where marks or blemishes will be more difficult to see. As shown in the drawings the styling feature 44 is an angled surface formed on the exterior surface 20 of the outer panel 18 where marks or blemishes will be difficult to see. Optionally the styling feature 44 is a connection surface for connecting an optional accent piece 50, which can be a functional or aesthetic molding, so any marks of blemishes on the exterior surface 20 will be covered.

In order to further limit the occurrence of marks and blemishes on the exterior surface 20 styling feature 44 of the outer panel 18, there is a rib 42a, 42b at a location opposite a styling feature 44 located on the inner surface 22 of the outer panel 18. The first end of the styling line reinforcement flange 46a, 46b is connected to the rib 42a, 42b respectively and spaces the styling line reinforcement 46a, 46b at a distance from the inner surface 22 which minimizes any visible defect on the exterior surface 20 of the outer panel 18.

While two styling line reinforcement flanges 46a, 46b and two nonvisual reinforcements flanges 38a, 38b are shown, it is within the scope of the invention for there to be more than one depending on the size of the tailgate 10. For example, in the present embodiment the styling line reinforcement flange 46a and the non-visual reinforcement flange 38a on the left side of the tailgate 10, and the styling line reinforcement flange 46b and the non-visual reinforcement flange 38b on the right side of the tailgate 10; however, there can also be additional styling line reinforcement flanges used depending on the needs of a particular application. The connection between both the styling line reinforcement flange 46a, 46b and the non-visual reinforcement flange 38a, 38b with the bonding surface 16 of the inner panel 12 is accomplished by one of an adhesive connection, ultrasonic welded connection or a resistive implant welded connection.

Each styling line reinforcement flange 46a, 46b provide several advantages when forming the outer panel 18, and when connecting the outer panel 18 to the inner panel 12. The outer panel 18 is formed of composite material, which means it is formed within a molding tool. During formation there are sliders in the molding tool that help to release the formed outer panel after molding in the tool is complete. The styling line reinforcement flange 46a, 46b provide a wide surface area that allows for sliders in the molding tool to push the outer panel 18 out of the tool upon completion of the forming of the outer panel 18. FIG. 10 shows a slider 53 on one side of the outer panel 18 in contact with the styling line reinforcement flange 46b, however a separate slider (not shown) on the opposite side where styling lines reinforcement flange 46b is also used. Additionally, each styling line reinforcement flange 46a, 46b extends between the respective intersect 48a, 48b and the rib 42a, 42b, at a distance from the inner surface 22 of the outer panel 18. This prevents the sliders in the mold tool from directly contacting the inner surface 22 and exterior surface 20 of the outer panel 18, which helps to prevent any blemishes from being created on the exterior surface 20 or inner surface 22 that can be created during removal of the outer panel 18 from the mold tool. Referring now to FIG. 11 during assembly of the tailgate 10, styling line reinforcement flange 46b provides a wide surface area for the application of adhesives 52 or other bonding or connection devices to be applied so that there is good contact between the styling line reinforcement flange 46b and the bonding surface 16 of the inner panel 12. While FIG. 11 shows only one side of the inner surface 22 of the outer panel 18, the same adhesive path is applied on the opposing side at the styling line reinforcement flange 46a.

The non-visual reinforcement flange 38a, 38b and the styling line reinforcement flange 46a, 46b eliminate visual blemishes on the exterior surface 20 of the outer panel 18, by extending respectively to the non-visual reinforcement flange 38a, 38b and the rib 42a, 42b. This also causes the non-visual reinforcement flange 38a, 38b and the styling line reinforcement flange 46a, 46b to be larger, which stiffens the outer panel 18, reduces deformation and provides better production tolerances between the inner panel 12 and outer panel 18.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A tailgate for a vehicle, comprising:
an inner panel having a bonding surface,
an outer panel having an exterior surface and an inner surface;
at least one light cavity formed in the outer panel and having an aperture of the at least one light cavity having a perimeter edge formed at the exterior surface and a plurality of side walls extending between the perimeter edge of the aperture and back wall of the at least one light cavity;
a non-visual surface region on the outer panel that has an outer surface that is a portion of the exterior surface of the outer panel and an inner region that is a portion of the inner surface of the outer panel; and
at least one non-visual reinforcement flange formed on the inner surface of the inner panel, the at least one non-visual reinforcement flange is connected at one end to the inner region of the non-visual surface region of the outer panel and at a second end to a backside surface of one of the plurality of side walls of the at least one light cavity the backside surface is part of the inner surface of the outer panel, wherein there is a connection between the at least one non-visual reinforcement flange and the bonding surface of the inner panel.

2. The tailgate of claim 1, wherein the connection between the at least one non-visual reinforcement flange and the bonding surface of the inner panel is accomplished by one of an adhesive connection, ultrasonic welded connection or a resistive implant welded connection.

3. The tailgate of claim 1, wherein the outer surface of the non-visual surface region is a window flange that is covered by a window.

4. The tailgate of claim 1 further comprising:
a styling feature formed on the exterior surface of the outer panel;
at least one rib extending from the inner surface of the outer panel at a location opposite the styling feature of the outer panel; and
at least one styling line reinforcement flange having a first end connected to the at least one rib and a second end connected to one of the plurality of side walls of the at least one light cavity, wherein there is a connection between the at least one styling line reinforcement flange and the bonding surface of the inner panel.

5. The tailgate of claim 4, wherein the connection between the at least one styling line reinforcement flange and the bonding surface of the inner panel is accomplished by one of an adhesive connection, ultrasonic welded connection or a resistive implant welded connection.

6. The tailgate of claim 4, wherein the non-visual surface region is a window flange covered by a window.

7. The tailgate of claim 4 wherein the styling feature is an angled surface formed on the exterior surface of the outer panel.

8. The tailgate of claim 4 further comprising:
an accent piece, and
wherein the styling feature is a connection surface for connecting the accent piece to the exterior surface of the outer panel.

9. A tailgate for a vehicle, comprising:
an inner panel having a bonding surface,
an outer panel having an exterior surface and an inner surface;
at least one light cavity formed in the outer panel and having an aperture of the at least one light cavity having a perimeter edge formed at the exterior surface and a plurality of side walls extending between the perimeter edge of the aperture and back wall of the at least one light cavity;
a styling feature formed on the exterior surface of the outer panel; and
at least one styling line reinforcement flange connected at one end to the inside surface of the outer panel at a location opposite the styling feature located on the exterior surface of the outer panel and at a second end to one of a plurality of side walls of the at least one light cavity, wherein there is a connection between the at least one styling line reinforcement flange and the bonding surface of the inner panel.

10. The tailgate of claim 9 wherein the styling feature is an angled surface formed on the exterior surface of the outer panel.

11. The tailgate of claim 9 further comprising:
an accent piece, and
wherein the styling feature is a connection surface for connecting the accent piece to the exterior surface of the outer panel.

12. The tailgate of claim 9 further comprising:
at least one rib extending from the inner surface of the outer panel at a location opposite the styling feature located on the bonding surface of the outer panel, and
at least one styling line reinforcement flange having a first end connected to the at least one rib and a second end connected to one of the plurality of side walls of the at least one light cavity, wherein there is a connection between the at least one styling line reinforcement flange and the bonding surface of the inner panel.

13. The tailgate of claim 9, wherein the connection between the at least one styling line reinforcement flange and the bonding surface of the inner panel is accomplished by one of an adhesive connection, ultrasonic welded connection or a resistive implant welded connection.

14. A tailgate for a vehicle, comprising:
an inner panel having a bonding surface,
an outer panel having an exterior surface and an inner surface;
at least one light cavity formed in the outer panel and having an aperture of the at least one light cavity having a perimeter edge formed at the exterior surface and a plurality of side walls extending between the perimeter edge of the aperture and back wall of the at least one light cavity;
a styling feature formed on the exterior surface of the outer panel, and
at least one styling line reinforcement flange connected at one end to the inside surface of the outer panel at a location opposite the styling feature located on the exterior surface of the outer panel and at a second end to one of a plurality of side walls of the at least one light cavity, wherein there is a connection between the at least one styling line reinforcement flange and the bonding surface of the inner panel;
a non-visual surface region on the outer panel that has an outer surface that is part of the exterior surface of the outer panel and an inner region that is a portion of the inner surface of the outer panel; and
at least one non-visual reinforcement flange formed on the inner surface of the inner panel, the at least one non-visual reinforcement flange has is connected to the inner region of the non-visual surface region of the outer panel and to a backside surface of one of the plurality of side walls of the at least one light cavity the backside surface is a portion of the inner surface of the outer panel, wherein there is a connection between the at least one non-visual reinforcement flange and the bonding surface of the inner panel.

15. The tailgate of claim 14, wherein the connection between the at least one non-visual reinforcement flange and the bonding surface of the inner panel is accomplished by one of an adhesive connection, ultrasonic welded connection or a resistive implant welded connection.

16. The tailgate of claim 14, wherein the outer surface of the non-visual surface region is a window flange that is covered by a window.

17. The tailgate of claim 14, wherein the connection between the at least one styling line reinforcement flange and the bonding surface of the inner panel is accomplished by one of an adhesive connection, ultrasonic welded connection or a resistive implant welded connection.

18. The tailgate of claim 14 wherein the styling feature is an angled surface formed on the exterior surface of the outer panel.

19. The tailgate of claim 14 further comprising:
an accent piece, and
wherein the styling feature is a connection surface for connecting the accent piece to the exterior surface of the outer panel.

20. A method of forming an outer panel for a vehicle comprising the steps of:
providing a mold tool having a mold surface having a forming cavity for forming an outer panel with an exterior surface and an inner surface;
providing at least one slider tool for sliding into the forming cavity and forming a non-visual reinforcement flange and a styling line reinforcement flange on the inside surface of the outer panel;
providing at least one rib forming surface in the forming cavity;
closing the mold tool and positioning the at least one slider tool in the forming cavity;
injecting resin that is uncured into the forming cavity and waiting for the resin to cure and form the outer panel;
retracting the at least one slider tool and opening the mold tool; and
removing the outer panel.
